(19) United States
(12) Patent Application Publication
(10) Pub. No.: US 2002/0043058 A1
(43) Pub. Date: Apr. 18, 2002

(54) Wheel assembly for a line weed trimmer

(76) Inventor: James William McBlair, Enid, OK (US)

Correspondence Address: James W. McBlair, 2113 E. Walnut, Enid, OK, 73701, US

(21) Appl. No.: 09/940,216

(22) Filed: Aug. 27, 2001

Related U.S. Application Data
(60) Provisional application No. 60/228,343, filed on Aug. 28, 2000.

(51) Int. Cl. A01D 34/84; A01D 34/67

(52) U.S. Cl. 56/12.7; 56/16.7

(57) ABSTRACT

A wheel assembly, mounted at two points by clamps, on a line trimmer drive shaft, which has two wheels. The assembly utilizes two L-shaped metal legs, bolted to the lower clamp, which allows mounting over the existing trimmer shield or “toe guard” and unimpeded use of the “bump cap” or “tap-n-go” line feed function of the trimmer. The L-shaped design also allows the use of shorter legs while still providing adequate clearance, and a more compact design. The second clamp on the trimmer drive shaft is located above the wheels and axle of the assembly and connects to the assembly with a two-piece metal strap which has bolt-holes at regular intervals. By changing bolt placement through the two-piece strap, the operator can adjust the entire trimmer to a comfortable working height. Additionally, the assembly uses metal mounting brackets, a center support, and an axle sleeve which provides a very ridgid assembly, stabilizes the entire trimmer machine, provides a uniform cut from the line trimmer head, and enables the operator to cut weeds along fence lines and on steep inclines with less fatigue and greater safety. Finally, with the exception of the two mounting clamps, the wheel assembly can be readily installed or removed for operator convenience.

| | | | |
|---|---|---|---|
| 4,531,350 | 7/85 | Hutchmacher | 56/17.5 |
| 5,092,112 | 3/92 | Buckendorf, Jr. | 56/17.5 |
| 5,450,715 | 9/95 | Murray | 56/17.5X |
| 5,477,665 | 12/95 | Stout | 56/16.7 |
| 5,484,154 | 1/96 | Ward | 280/47.24X |
| 5,626,006 | 5/97 | Fricke, Sr. | 56/6.7X |
| 5,836,142 | 11/98 | Maxwell | 56/12.1 |
| 6,065,275 | 5/00 | Pope | 56/12.7 |

### BACKGROUND

Line weed trimmers are awkward to hold and use and cause a great deal of fatigue to the operator during extended periods of operation. Further, line weed trimmers are extremely difficult to use on steep inclines, such as ditches. They are inherently heavy and unstable, must be picked up and carried while in use, and usually requires both hands to operate. The invention contained in this application, wheel assembly for a line weed trimmer, addresses these problems, and more.

Several attempts have been made to improve the funtions of line weed trimmmers over the last several years. U.S. Pat. No. 4,531,350 (Hutchmacher, July 1985) uses three wheels, which interferes with the cutter line on the trimmer. U.S. Pat. Nos. 5,092,112 (Buckendorf, Jr. March 1992); 5,450,715 (Murray September 1995); and 5,477,665 (Stout December 1995), all use a one point attachment which is unstable and awkward to handle. U.S. Pat. No. 5,626,006 (Fricke, Sr. May 1997) and No. 5,836,142 (Maxwell November 1998) both employ a two-wheeled system, attached at two points on the trimmer drive shaft but, the Maxwell patent is the best prior art work known to this applicant. However, the Maxwell patent leaves several problems unresolved which are addressed by this patent application. The ability to adjust the height of the machine and clearance of the toe guard, which will allow easy use of the automatic line feed system, are the most compelling.

### BRIEF SUMMATION OF THE INVENTION

The purpose of this invention is . . .

1. To allow the use of a line weed trimmer with fewer back injuries.

2. To cut vegetation on steep inclines easily and safely.

3. To provide a useable set of wheels for weed trimmers which are inexpensive, easy to install and remove, and does not require modifications to the weed trimmer.

4. To provide a wheel assembly which is light weight yet strong.

5. To allow the use of the automatic line feed function without interference.

6. To provide a means to adjust the height of the weed trimmer to a comfortable working height for the operator.

### BRIEF DESCRIPTION OF THE DRAWING VIEWS

FIG. 1 is a side view of the wheel assembly mounted on a line weed trimmer.

FIG. 2 is the top view of the wheel assembly mounted on a line weed trimmer.

FIG. 3 is an exploded view of the entire wheel assembly.

### DETAILED DESCRIPTION OF THE INVENTION

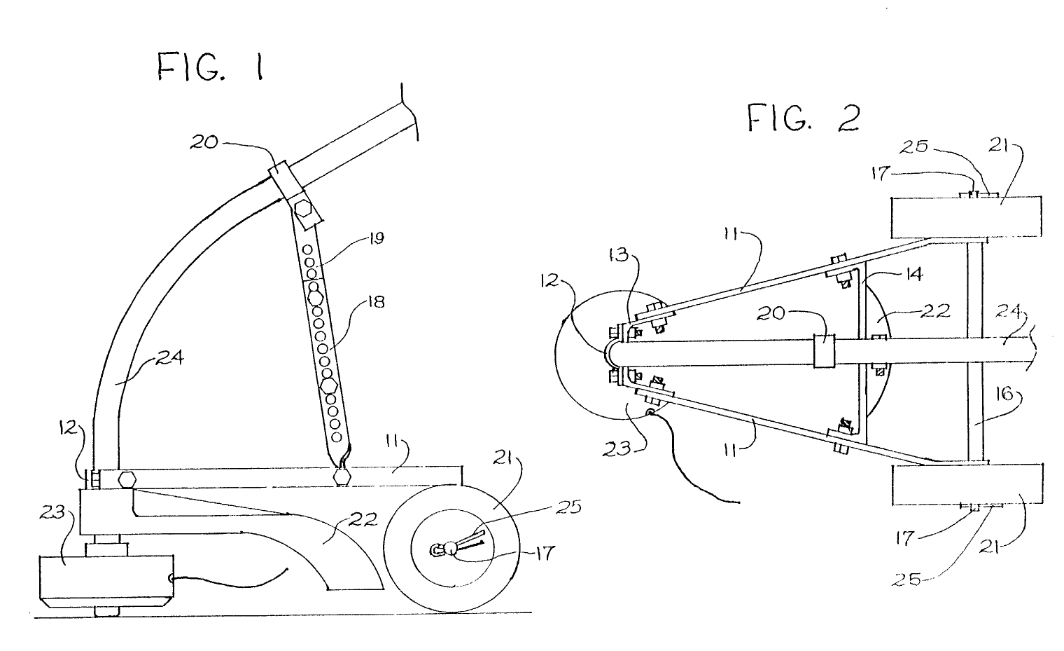

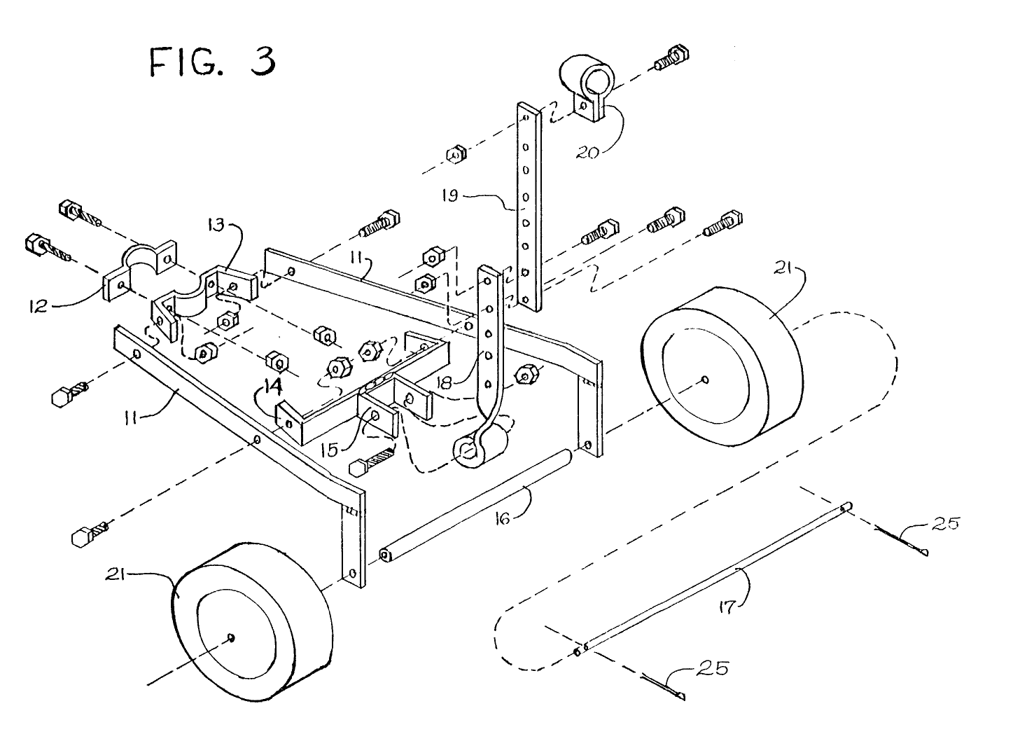

Referring to all FIGURES, but in particular to FIG. 1, which is a side view of the wheel assembly mounted to a line weed trimmer, bottom bracket 12 (and 13 shown in FIG. 2 and FIG. 3) is mounted to the line trimmer drive shaft 24, immediately above the line trimmer shield 22. Leg 11 is bolted to the bottom bracket 12 (and 13 shown in FIG. 2 and FIG. 3) and extends beyond the trimmer shield 22 where an axle shaft 17 is inserted through axle shaft holes (shown in FIG. 3). Rubber tire 21 is then mounted on the axle shaft 17 and held in place by a cotter pin 25. FIG. 1 also shows the attachment/adjustment apparatus 18 and 19 bolted together and attached to the top clamp 20 and also attached to the bottom bracket 15 (shown in FIG. 3). The top clamp 20 is attached to the drive shaft assembly 24 at a convenient position above the wheel assembly.

FIG. 2 is a view looking down from above the wheel assembly which is mounted on a line weed trimmer. Several parts are seen in FIG. 2 which are hidden in FIG. 1. The entire front mounting bracket 12 and 13 is visible from above and shows the attachment of the legs 11 to the bracket. Further back, along the legs, is the dual purpose center bracket 14 which stiffens the assembly and provides an attachment point for the bottom bracket 15 (shown only in FIG. 3). At the wheel end of the assembly, the spacer/sleeve 16 is shown mounted between the two legs 11 and provides added rigidity to the assembly and covers the axle shaft 17.

FIG. 3 is an exploded view of only the wheel assembly invention. Any pieces or parts hidden from view in FIG. 1 or FIG. 2 are readily apparent in FIG. 3. The front section of the bottom bracket 12 and the rear section of the bottem bracket 13 are bolted together around the drive shaft 24. Each leg 11 is then bolted to the back section of the bottom bracket 13. The dual purpose center bracket 14 and 15 is bolted onto each leg 11. The axle shaft 17 is inserted through the axle shaft hole, on either leg 11 then inserted through the spacer/sleeve 16 and through the other axle shaft hole on the opposite leg 11. Once the axle shaft 17 is in place, both tires 21 are installed over the axle shaft 17 and held in place with cotter pins 25. The bottom section of the mounting/adjustment apparatus 18 is inserted into bracket 15 and bolted into place. The top section of the mounting/adjustment apparatus 19 is bolted to the bottom section 18 with two bolts, which allows the apparatus to be adjusted for length as necessary. Finally, the top section of the mounting/adjustment apparatus 19 is bolted to the top clamp 20, which is clamped around the drive shaft 24.

Operation

Once the wheel assembly has been assembled, it is clamped to the drive shaft 24 at the bottom, immediately above the shield, by bracket 12 and 13, and above the assembly at clamp 20. The distance from the wheels 21 to the mounting clamp 20 can be adjusted by removal of the two bolts which bolt top section 19 to bottom section 18 of the center mounting/adjustment apparatus and reallignment of the holes on bottom section 18 and top section 19. After the desired length has been obtained, reinstall the two bolts through the holes in bottom section 18 and top section 19. Once the wheel assembly has been installed on the line weed trimmer and adjusted to the desired length, the trifler can be operated by simply pushing it around on the wheel assembly.

Conclusions

A wheel assembly has been illustrated which clearly permits easier operation of a line weed trimmer. The addition of a wheel assembly to the trimmer offers safer operation, less fatigue, and greater versatility for the user.

It is obvious that other modifications and changes can be made and still be well within the spirit and scope of this invention as described in the specifications.

What I claim as my invention is:

1. A wheeled assembly for a line weed trimmer mounted at two points on the drive shaft of the trimmer comprising:
(a) Two wheels attached, one on each end, of a single axle.
(b) A single axle shaft with cotter pin holes drilled through, a short distance from each end.
(c) A spacer/sleeve through which the axle is inserted.
(d) Two L-shaped legs having holes through which the axle shaft, spacer/sleeve, and wheels are mounted. Holes are also provided on the L-shaped legs for mounting a dual-purpose center bracket and to attach the wheel assembly to the lower, front clamp.
(e) A dual-purpose center bracket bolted between the two L-shaped legs.
(f) A two piece mounting/adjustment apparatus which is attached to the dual-purpose center bracket at the bottom end and attached to a “loop style” clamp at the top end.
(g) A “loop style” clamp attached to the trimmer drive shaft located above the dual-purpose center bracket.
(h) A two-piece clamp mounted directly above the “toe guard” of the weed trimmer to which the front end of the L-shaped legs are attached.

2. As referred to in claim 1, Two L-shaped legs attached to the weed trimmer by a clamp on one end and containing the axle assembly on the other end.

3. As referred to in claim 1, a dual-purpose center bracket bolted between the two L-shaped legs.

4. As referred to in claim 1, a spacer/sleeve through which the axle is inserted.

5. As referred to in claim 1, a two-piece clamp which has short mounting legs with drilled holes on the back section of the clamp.

6. As referred to in claim 1, a “loop style”clamp.

7. As referred to in claim 1, a two-piece mounting/ adjustment apparatus which is bolted together in the center.

8. As referred to in claim 5, a two-piece clamp with short mounting legs to which the front section of the L-shaped legs is attached by bolts and wing nuts.

9. As referred to in claim 7, a two-piece mounting/adjustment apparatus which is bolted on one end to the top “loop style” clamp with a bolt and wing nut, and on the other end to the dual-purpose center bracket.
